(19) United States
(12) Patent Application Publication
(10) Pub. No.: US 2006/0176953 A1
(43) Pub. Date: Aug. 10, 2006

(54) Method and system for video encoding with rate control

(76) Inventor: Nader Mohsenian, Lawrence, MA (US)

Correspondence Address: MCANDREWS HELD & MALLOY, LTD, 500 WEST MADISON STREET, SUITE 3400, CHICAGO, IL, 60661, US

(21) Appl. No.: 11/051,308

(22) Filed: Feb. 4, 2005

(51) Int. Cl. H04N 11/04; H04B 1/66; H04N 11/02; H04N 7/12

(52) U.S. Cl. 375/240.03; 375/240.23

(57) ABSTRACT

Described herein is a rate controller in a video system. The rate controller is comprised of a bit count estimator and a quantization selector. The bit count estimator receives an input to an encoder and generates a bit count estimate. The bit count estimate is an approximation of a bit count at an output of the encoder. The quantization selector sets a quantization value based on the bit count estimate.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In video communications applications it is often necessary to transmit at a fixed bit rate. Extra amounts of information transmitted beyond the fixed bit rate may be discarded, and transmitting at a lower bit rate would be a waste of bandwidth. When the bandwidth is wasted, video quality is less than ideal. Similarly, when preparing a video stream for media storage, (e.g. DVD) it is desirable to populate the disk to the maximum capacity such that no disk partition is wasted.

Encoded video takes advantage of spatial and temporal redundancies to achieve compression. Video compression systems also exploit the statistical redundancies in video sources by entropy encoding. Even though cutting edge video encoders make use of sophisticated tools to de-correlate spatial, temporal, and spectral sample dependencies, there are still some hidden statistical redundancies which remain embedded in the stream. Thorough identification of such redundancies is advantageous for reducing the size of the final output video stream. Since video sources are non-stationary in statistical sense, advanced entropy coders can take advantage of context modeling to adapt to changes in the source and achieve better compaction.

With advanced entropy encoding, bits output from a video encoder can be delayed by the inherent complexity of this encoding technique.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are systems and methods for use in encoding video data.

In one embodiment of the invention, a video encoder system with a rate controller is presented. Two encoders encode video data. The rate controller selects a quantization level based on an output of one encoder, while an output of the other encoder is used to send or store data.

In another embodiment, a method for rate control is presented. A bit count estimate is generated based on a simple encoder. The bit count estimate is an estimate of a bit count at an output of a more complex encoder. A quantizer level is selected based on the bit count estimate.

In another embodiment, an integrated circuit for controlling bit rate in a video encoder is presented. The integrated circuit comprises arithmetic logic and memory. The arithmetic logic is operable to calculate a bit count estimate for a picture using a simple encoder and generate an encoder output using a more complex encoder. The memory is operable to store quantization levels that may be used by the video encoder. The arithmetic logic selects a quantization level to be used by the video encoder based on the bit count estimate.

These and other advantages and novel features of the present invention, as well as illustrated embodiments thereof, will be more fully understood from the following description and drawings.

### BRIEF DESCRIPTION OF THE DRAWINGS

FIG. 1 is a block diagram of a comparison between the processing rates of two entropy encoders;

FIG. 2 is a block diagram of an exemplary video system with a rate controller in accordance with an embodiment of the present invention;

FIG. 3 is a flow diagram of an exemplary method for video encoding with rate control in accordance with an embodiment of the present invention;

FIG. 4 is a block diagram of a picture;

FIG. 5A is a block diagram describing spatially encoded macroblocks;

FIG. 5B is a block diagram describing temporally encoded macroblocks;

FIG. 5C is a block diagram describing the encoding of a prediction error; and

FIG. 6 is a video encoder in accordance with another embodiment of the present invention.

### DETAILED DESCRIPTION OF THE INVENTION

According to certain aspects of the present invention, a system and method for rate control are presented. A target bit rate can be met since an estimate of bit count is generated in real-time even while advanced entropy encoders are enabled.

Most video applications require the compression of digital video for transmission, storage, and data management. A video encoder performs the task of compression. The video encoder takes advantage of spatial, temporal, spectral, and statistical redundancies to achieve compression. Entropy encoding is well suited for the removal of statistical redundancies. With advanced entropy encoding, the number of bits (or bit rate) output from an entropy encoder in the video encoder can be fed back to a rate controller quickly, but the inherent complexity of advanced entropy encoding may delay the generation of these output bits. If the video encoder cannot estimate an accurate number of bits in real-time with an advanced entropy encoder, the video encoder would have to resort to using a simpler (less efficient) entropy encoder to generate the video encoder output. The use of less efficient entropy encoders reduces the overall compression ratio of a system, and output quality suffers.

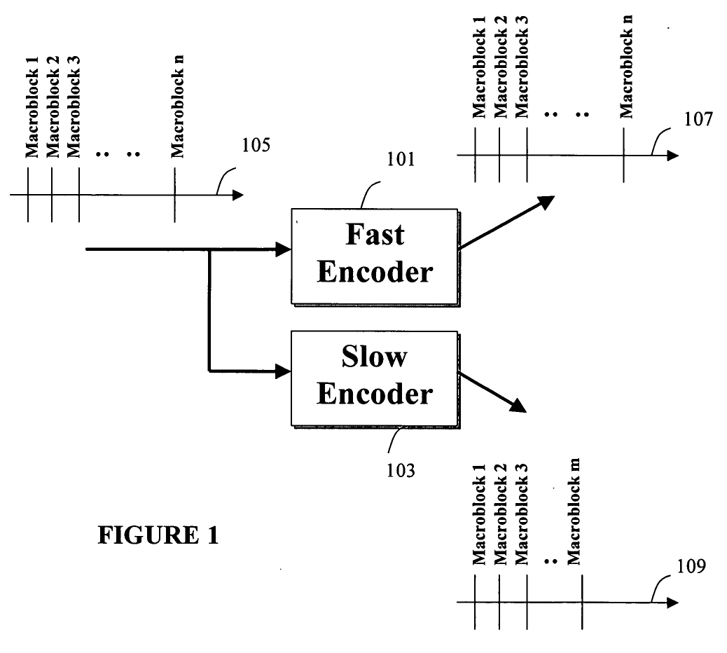

FIG. 1 is a block diagram of a comparison between the processing rates of two entropy encoders. A fast encoder 101 can compensate for the processing delay in a slow encoder 103 and provide a seamless transition in video quality at data boundaries where there could be a bottleneck. The fast encoder 101 and the slow encoder 103 receive an input 105 of macroblocks 1 through n. The fast encoder output 107 is available for macroblocks 1 through n, and the slow encoder output 109 is available for macroblocks 1 through m. A rate controller may require an accurate bit count at the slow encoder output 109, so there are three scenarios:

1) [m=n] The total accumulated number of bits at the slow encoder output 109 for macroblocks 1 through n is available, and this value is provided to the rate controller;

2) [m<n] Only the total accumulated number of bits at the slow encoder output 109 for macroblocks 1 through m is available; and

3) [m=0] No count is available.

Partial bits would be available when the output of the slow encoder 103 lags a preprocessor by a few macroblocks, but not exceeding the boundary of the picture. Partial bits can be combined with the bit count estimate to produce a new bit count estimate. For the scenario when no count is available, the delay of the slow encoder 103 is larger than n macroblocks; the slow encoder 103 is still busy processing data in a previous picture, and sampling of a current picture has not begun. Since a lag is created, there is no contribution from an actual bit count in a bit count estimate, and the best estimate of delayed bits is wholly based on the fast encoder output 107.

Moving Picture Experts Group (MPEG)

The Moving Picture Experts Group (MPEG) standardizes digital video encoding. One exemplary standard is the ITU-H.264 Standard (H.264). H.264 is also known as MPEG-4, Part 10, and Advanced Video Coding. In the H.264 standard video is encoded on a picture-by-picture basis, and pictures are encoded on a macroblock by macroblock basis. H.264 specifies the use of spatial prediction, temporal prediction, transformation, interlaced coding, and lossless entropy coding to compress the macroblocks. The term picture is used throughout this specification to generically refer to frames, fields, macroblocks, or portions thereof.

Using the MPEG compression standards, video is compressed while preserving image quality through a combination of spatial, temporal, and spectral compression techniques. To achieve a given Quality of Service (QoS) with an even smaller bandwidth, video compression systems exploit the statistical redundancies in video sources. Cutting edge video encoders make use of sophisticated tools to de-correlate spatial, temporal, and spectral sample dependencies, but there are still some hidden statistical redundancies that remain embedded in the stream. Thorough identification of such redundancies plays a major role in reducing the size of the final output video stream. These redundancies are higher order correlations that are next to impossible to distinguish with low order predictors and are best identified via entropy coders. Since video sources are non-stationary in statistical sense, advanced entropy coders can take advantage of context modeling to adapt to changes in the source and achieve better compaction.

MPEG-2 specifies Variable-Length Coding (VLC) for entropy coding. MPEG-4 specifies two more complex types of entropy coding: Context-based Adaptive Binary Arithmetic Coding (CABAC) and Context-based Adaptive Variable-Length Coding (CAVLC). CABAC produces the most efficient compression, especially for high color images.

Variable Length Coding (VLC)

Variable Length Coding (VLC) includes three stages: Zig-Zag Scanning, Run Length Encoding (RLE), and Huffman Coding. In Zig-Zag Scanning quantized coefficients are read out in a zig-zag order that typically corresponds to increasing vertical and horizontal frequencies. Run Length Encoding (RLE) is used to code a string of data following the zig-zag scanning. Run length encoding codes the quantized coefficients in a block into a run length (or number of occurrences) and a level or amplitude. For example, if four coefficients of value “10” are transmitted as: {10, 10, 10, 10}. By using RLE, the level is 10 and the run of a value of 10 is four. Therefore, {4, 10} is transmitted, and the amount of transmitted data is reduced. Huffman Coding is used to represent symbols from the RLE such that no bit string of a symbol is a prefix of the bit string of another symbol. This expresses the most common characters in the shortest way possible.

Context-Based Adaptive Arithmetic Coding (CABAC)

CABAC includes Binarization, Context Model Selection, Arithmetic Encoding, and Context Model Updating. Binarization converts a non-binary-valued symbol into a binary code prior to arithmetic coding. Quantized input values are reduced in range to create symbols of one's and zeros for each input value. The result of Binarization is called a bin string or bins. Context Model Selection is used to determine an accurate probability model for one or more bins of the bin string. The context modeler samples the input bins and assigns probability models based on a frequency of observed bins. This model may be chosen from a selection of available models depending on the statistics of recently coded data symbols. The context model stores the probability of each bin being “1” or “0”. With Arithmetic Encoding each bin is encoded according to the selected context model. There are just two sub-ranges for each bin: corresponding to “0” and “1”. A mapping engine utilizes the context model and assigns bits to input bins. Generated bits are to be embedded in an outgoing video stream. Context model updating is based on the actual coded value (e.g. if the bit value was “1”, the frequency count of “1”s is increased). The same generated bits that are to be embedded in the outgoing video stream are fed back to context modeling to update probabilities of observed events.

A more complex entropy engine, such as the CABAC, is responsible for creation of a final (true) compressed stream since it results in better information compaction. A less complex entropy engine, such as the VLC, can be responsible for fast throughput of actual bits in instances where a bit count is required.

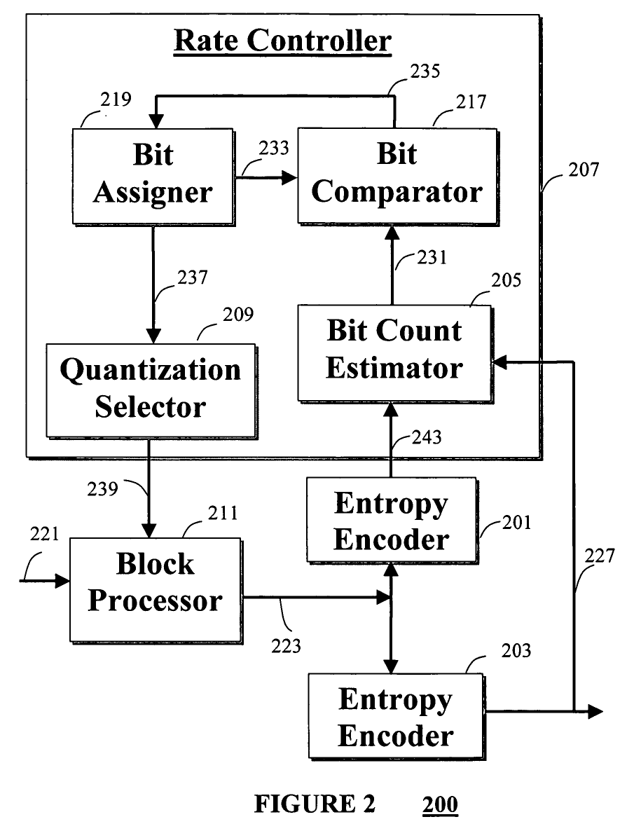

In FIG. 2, a block diagram of an exemplary video system 200 with a rate controller 207 is presented. The rate controller 207 is comprised of a bit count estimator 205, a bit comparator 217, a bit assigner 219, and a quantization selector 209. In addition to the rate controller 207, the video system 200 includes a first entropy encoder 201, a second entropy encoder 203, and a block processor 211.

Source video 221 is input to a block processor 211. The block processor 211 may be responsible for transformation, quantization, motion estimation, motion compensation, and inverse transformation. A block processor output 223 enters the first entropy encoder 201 and the second entropy encoder 203. The second entropy encoder 203 produces an encoder output 227. The second entropy encoder 203 may perform CABAC as described earlier in reference to MPEG-4. In some cases, the bit count estimator 205 can use the encoder output 227 as a part of the bit count estimate 231.

Typically, it is necessary to have an accurate and current count of the bits in the video encoder output 227 in order to maintain a fixed bit rate. When the second entropy encoder 203 is complicated, there could be a processing delay that prohibits a direct count of the bits in the video encoder output 227 in real-time. The processing delay can be a function of aspects such as bit rate and picture complexity, and during a scene change, the second encoder 203 can fall behind the block processor 211. The first entropy encoder 201 can be used to generate a bit count 243. The first entropy encoder 201 may be a Bin Coder that converts the block processor output 223 into binarized symbols. The binarized symbols can be used as the bit count estimate. The first entropy encoder 201 may also be another standardized encoder. For example, a VLC encoder is relatively fast while a CABAC encoder can take more time. Therefore, the VLC encoder could be used as the first entropy encoder 201 while the CABAC encoder is used as the second entropy encoder 203. The complexity of an adaptive entropy encoder, such as CABAC, may be due to silicon technology limitations and the fact that accurate probability models require the processing of a large number of samples. While the context adaptive entropy engine is occupied with digesting the sample field, the rest of the video encoder hardware or software blocks will move forward in time. Very large pictures or very high bit rates further advance the delay. Further, some static sequences might be comprised of a super-sized picture. Consequently, the encoder output 227 can be delayed from time to time when certain modules of the video encoders would want to sample them instantly.

One or more bit count estimator functions can be generated off-line and have either constant or picture adaptive parameters. Examples of a bit count estimator function that can generate an estimate 231 of the true bit count 227 based on a bit count 243 of the first entropy encoder 201 may be:
first order: “231”=a₀+a₁×(“243”);
quadratic: “231”=a₀+a₁×(“243”)+a₂×(“243”²); or
higher order: “231”=a₀+a₁×(“243”)+ . . . +a_{N}×(“243”^{N}).
Coefficients, a₀, a₁, a₂, . . . a_{N}, can remain constant or adapt to the content of the video in real-time. In the latter case, the encoder output 227 of the second entropy encoder 203 is supplied to the bit count estimator function in the bit count estimator 205 to fine-tune coefficients, a₀, a₁, a₂, . . . a_{N}, as the statistical nature of the source changes over time. The bit count estimator function may keep useful operating points and discard unnecessary data. For example, points taken from a certain scene should not be used to estimate bits in another scene, and different bit count estimator functions can be adopted to accommodate delays in different picture types. The bit count estimator function may be designed in arithmetic logic as a co-processor.

The rate controller 207 is responsible for meeting a set bit-rate for the compressed video stream. However, due to the complexity of entropy encoders such as the CABAC encoder, it might take significant clock cycles to process enough bins to deduce reliable probability functions necessary to generate the encoder output. In this case, the encoder output 227 is not accessible by the rate controller 207. This means the encoder output 227 would be ready sometimes in the future as a feedback. The rate controller 207 solves this delay bottleneck by using the first entropy encoder 201 that is much faster.

The bit assigner 219 of the rate controller 207 computes a balance defined as ideal bits 233 against which the bit count estimate 231 is compared. The ideal bits 233 may be assigned for an accumulated number of macroblocks. The bit assigner 219 could be different for a group of pictures, a picture, a series of macroblocks, or other collection of image samples. The comparison in the form of delta bits 235 is input back to the bit assigner 219. Another bit assigner output 237 is used to select a quantization level 239 for the block processor 211. A series of quantization levels may be precomputed and stored in memory. The functions of the rate controller 207 may be implemented in arithmetic logic.

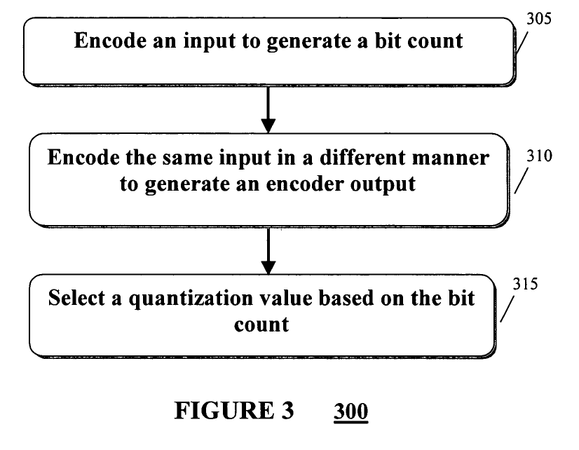

FIG. 3 is a flow diagram of an exemplary method for rate control 300. Encode an input to generate a bit count 305. Encode the same input in a different manner to generate an encoder output 310. Select a quantization value based on the bit count 315.

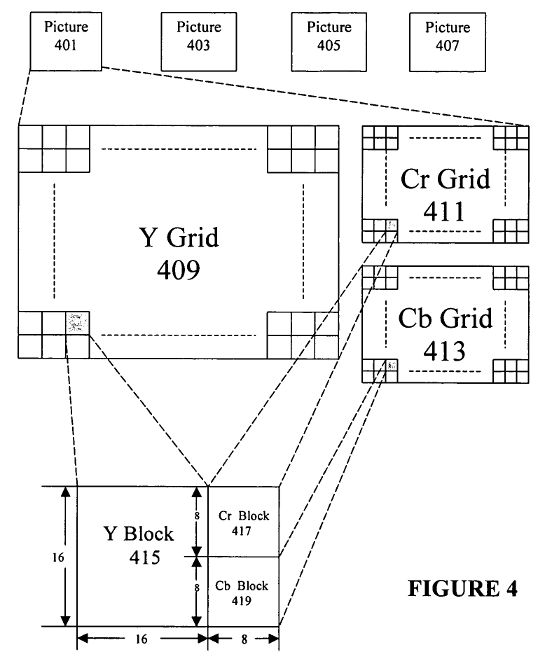

Referring now to FIG. 4, there is illustrated a block diagram of a picture 401. The term picture may refer to: a progressive frame (e.g. Film, animation, etc. . . . ), a top field of an interlaced frame, a bottom field of an interlaced frame, or two fields interleaved together to form an interlaced frame.

The picture 401 along with successive pictures 403, 405, and 407 form a video sequence. The picture 401 comprises two-dimensional grid(s) of pixels. For color video, each color component is associated with a unique two-dimensional grid of pixels. For example, a video can include a luma, chroma red, and chroma blue components. Accordingly, these components are associated with a luma grid 409, a chroma red grid 411, and a chroma blue grid 413. When the grids 409, 411, 413 are overlayed on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 409 compared to the chroma red grid 411 and the chroma blue grid 413. In the MPEG 4:2:0 standard, the chroma red grid 411 and the chroma blue grid 413 have half as many pixels as the luma grid 409 in each direction. Therefore, the chroma red grid 411 and the chroma blue grid 413 each have one quarter as many total pixels as the luma grid 409.

The luma grid 409 can be divided into 16×16 pixel blocks. For a luma block 415, there is a corresponding 8×8 chroma red block 417 in the chroma red grid 411 and a corresponding 8×8 chroma blue block 419 in the chroma blue grid 413. Blocks 415, 417, and 419 are collectively known as a macroblock that can be part of a slice group.

Spatial Prediction

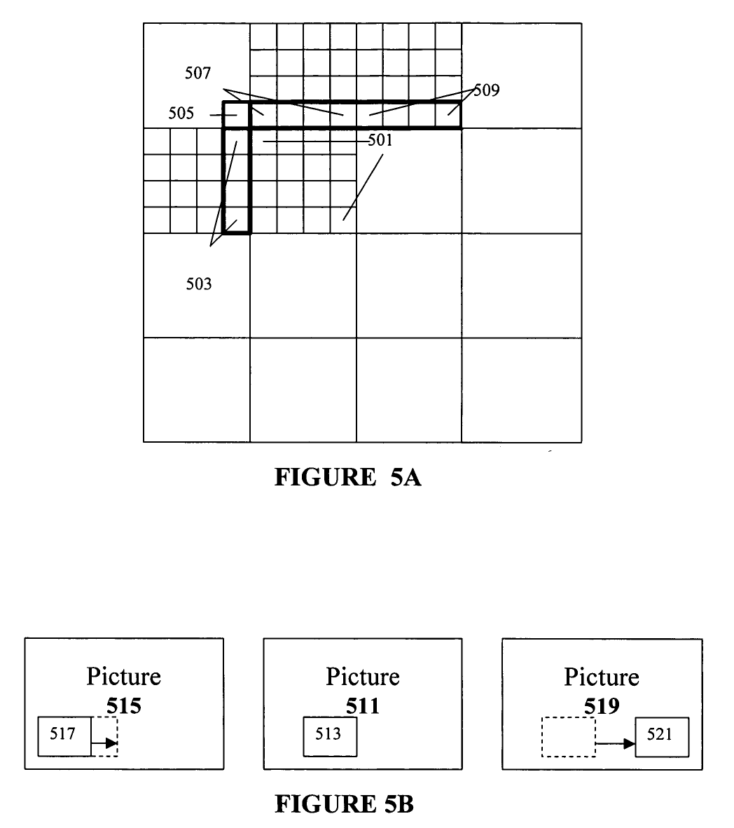

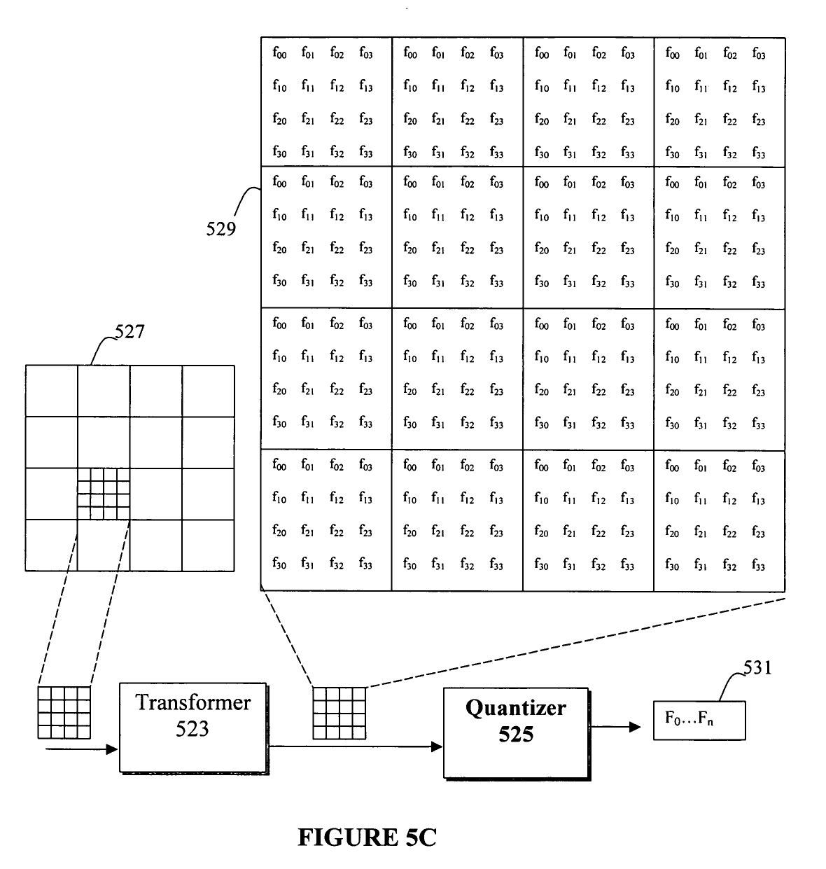

Referring now to FIG. 5A, there is illustrated a block diagram describing spatially encoded macroblocks. Spatial prediction, also referred to as intraprediction, involves prediction of picture pixels from neighboring pixels. The pixels of a macroblock can be predicted, in a 16×16 mode, an 8×8 mode, or a 4×4 mode. A macroblock is encoded as the combination of the prediction errors E representing its partitions.

In the 4×4 mode, a macroblock 501 is divided into 4×4 partitions. The 4×4 partitions of the macroblock 501 are predicted from a combination of left edge partitions 503, a corner partition 505, top edge partitions 507, and top right partitions 509. The difference between the macroblock 501 and prediction pixels in the partitions 503, 505, 507, and 509 is known as the prediction error. The prediction error is encoded along with an identification of the prediction pixels and prediction mode.

Temporal Prediction

A temporally encoded macroblocks can be divided into 16×8, 8×16, 8×8, 4×8, 8×4, or 4×4 partitions. Each partition of a macroblock, is compared to one or more prediction partitions in another picture(s). The difference between the partition and the prediction partition(s) is known as the prediction error. A macroblock is encoded as the combination of the prediction errors representing its partitions. The prediction error is encoded along with an identification of the prediction partition(s) that are identified by motion vectors. Motion vectors describe the spatial displacement between partitions.

Referring now to FIG. 5B, there is illustrated a block diagram describing temporally encoded macroblocks. In bi-directional coding, a first partition 513 in a first picture 511 that is being coded is predicted from a second partition 517 in a second picture 515 and a third partition 521 in a third picture 519. Accordingly, a prediction error is calculated as the difference between the weighted average of the prediction partitions 517 and 521 and the partition 513 in a first picture 511. The prediction error and an identification of the prediction partitions are encoded. Motion vectors identify the prediction partitions.

The weights can also be encoded explicitly, or implied from an identification of the picture containing the prediction partitions. The weights can be implied from the distance between the pictures containing the prediction partitions and the picture containing the partition.

Transportation, Quantization, and Scanning

Referring now to FIG. 5C, there is illustrated a block diagram describing the encoding of the prediction error. A macroblock is encoded as the combination of its partitions. A macroblock is represented by an error for both spatial prediction and temporal prediction. The prediction error is also a two-dimensional grid of pixel values for the luma Y, chroma red Cr, and chroma blue Cb components with the same dimensions as the macroblock.

The transformer 523 transforms 4×4 partitions of the prediction error 527 to the frequency domain, thereby resulting in corresponding sets of frequency coefficients 529. The sets of frequency coefficients 529 are then passed to a quantizer 525 and scanned, resulting in set of quantized frequency coefficients, F₀ . . . Fₙ 531. The quantizer 525 can be programmed with a variable quantization level as described in FIG. 2 with reference to the quantization selector 209.

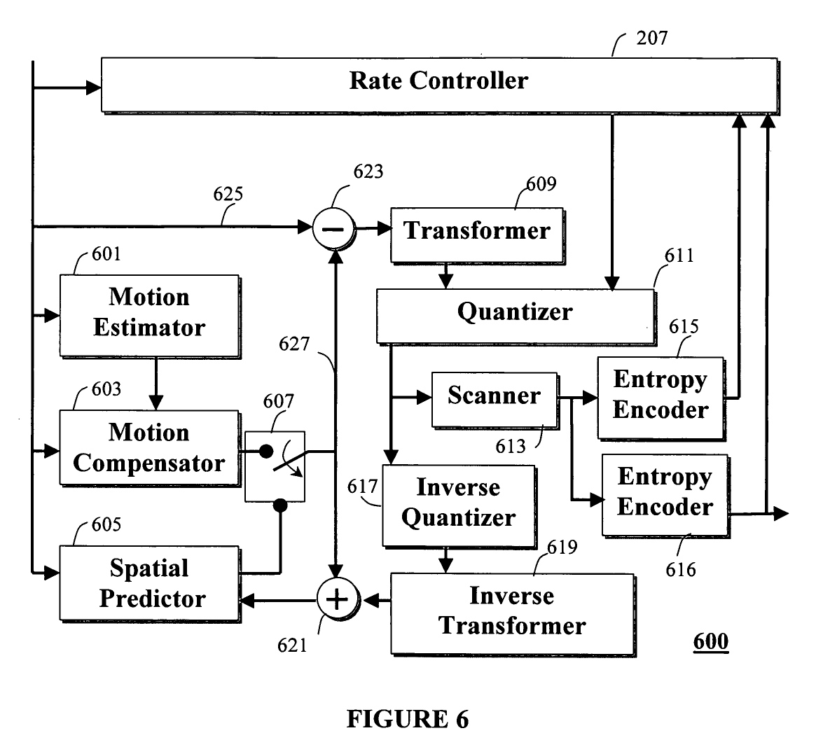

Referring now to FIG. 6, there is illustrated a block diagram describing an exemplary video encoder 600 in accordance with an embodiment of the present invention. The video encoder 600 encodes video data 625 comprising a set of pictures. The video encoder 600 comprises a motion estimator 601, a motion compensator 603, a spatial predictor 605, a transformer 609, a quantizer 611, a scanner 613, an entropy encoder 615, an inverse quantizer 617, and an inverse transformer 619. Another entropy encoder 616 is also utilized. The foregoing can comprise hardware accelerator units under the control of a CPU.

When video data 625 is presented for encoding, the video encoder 600 processes in units of macroblocks. The video encoder 600 can encode each macroblock using either spatial or temporal prediction. In each case, the video encoder forms a prediction block 627 that can be selected by a switch 607. In spatial prediction mode, the spatial predictor 605 forms the prediction block 627 from samples of the current picture 625 and one that was previously encoded. In temporal prediction mode, the motion estimator 601 and motion compensator 603 form a prediction macroblock 627 from one or more reference pictures. Additionally, the motion estimator 601 and motion compensators 603 provide motion vectors identifying the prediction block. The motion vectors can also be predicted from motion vectors of neighboring macroblocks.

A subtractor 623 subtracts the prediction macroblock 627 from the macroblock in the current picture 625, resulting in a prediction error. The transformer 609 and quantizer 611 transform and quantize the prediction error, resulting in a set of quantized transform coefficients. The scanner 613 reorders the quantized transform coefficients. The entropy encoders 615 and 616 encode the coefficients.

With reference to FIG. 2 and FIG. 6, the rate controller 207 can be used to measure complexity and select the quantization level 239 that best maintains a desired bit rate. The output from both entropy encoders 615 and 616 are available to the rate controller 207. Typically one entropy encoder is slow and more efficient while the other entropy encoder is fast and less efficient. The fast entropy encoder output reduces delay in rate control, and the more efficient entropy encoder output optimizes bandwidth utilization. A series of quantization levels may be precomputed and stored in memory. The storage and selection of the quantization levels may occur in the rate controller 207 or the quantizer 611.

The video encoder also decodes the quantized transform coefficients, via the inverse quantizer 617 and the inverse transformer 619. The decoded transform coefficients are added 621 to the prediction macroblock 627 and used by the spatial predictor 605.

The embodiments described herein may be implemented as a board level product, as a single chip, application specific integrated circuit (ASIC), or with varying levels of a video classification circuit integrated with other portions of the system as separate components.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

Limitations and disadvantages of conventional and traditional approaches will become apparent to one of ordinary skill in the art through comparison of such systems with the present invention as set forth in the remainder of the present application with reference to the drawings.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-4 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for video encoding, said method comprising:
encoding an input using a first entropy encoder, thereby generating a bit count;
encoding the input using a second entropy encoder, thereby generating an encoder output; and
setting a quantization value based on the bit count.

2. The method of claim 1, wherein the first entropy encoder further comprises a Variable Length Coder.

3. The method of claim 1, wherein the first entropy encoder further comprises a Context-based Adaptive Variable Length Coder.

4. The method of claim 1, wherein the second encoder comprises a Context-Based Adaptive Binary Arithmetic Coder.

5. The method of claim 1, wherein setting a quantization value comprises:
generating a bit count estimate based on the bit count; and
selecting the quantization value based on the bit count estimate.

6. The method of claim 1, wherein the method further comprises:
generating a bit count estimate based on the bit count;
comparing the bit count estimate to an ideal bit count, thereby producing a difference;
selecting the quantizer value based on the difference; and
utilizing the quantizer value in a block processor, wherein the block processor produces the input.

7. The method of claim 1, wherein the method further comprises:
setting the quantization value based on the encoder output.

8. A video encoding system, said video encoding system comprising:
a first encoder for receiving an input and generating a bit count; and
a second encoder for receiving the input and generating an encoder output; and
a rate controller for setting a quantization value based on the bit count.

9. The video encoding system of claim 8, wherein the first encoder further comprises a Bin Coder.

10. The video encoding system of claim 8, wherein the second encoder is a Context-Based Adaptive Binary Arithmetic Coder.

11. The video encoding system of claim 8, wherein the rate controller comprises:
a bit count estimator for generating a bit count estimate based on the bit count; and
a quantization selector for setting the quantization value based on the bit count estimate.

12. The video encoding system of claim 8, wherein the rate controller further comprises:
a bit count estimator for generating a bit count estimate based on the bit count;
a bit comparator for comparing the bit count estimate to an ideal bit count, thereby producing a difference; and
a quantization selector for selecting the quantizer value based on the difference.

13. The video encoding system of claim 8, wherein the quantizer value is utilized by a block processor, wherein the block processor produces the input.

14. The video encoding system of claim 8, wherein the quantization value of the rate controller is based on the bit count and the encoder output.

15. An integrated circuit for video encoding, said integrated circuit comprising:
arithmetic logic operable to encode an input and generate a bit count and an encoder output, wherein the bit count is generated by a first encoding process and the encoder output is generated by a second encoding process; and
memory for storing one or more quantization levels;
wherein the bit count is used to select a quantization level in the one or more quantization levels.

16. The integrated circuit of claim 15, wherein the first encoding process produces bins.

17. The integrated circuit of claim 15, wherein the second encoding process is Context-Based Adaptive Binary Arithmetic Coding.

18. The integrated circuit of claim 15, wherein selecting the quantization level comprises:
generating a bit count estimate based on the bit count and the encoder output; and
selecting a quantizer level based on the bit count estimate.

19. The integrated circuit of claim 15, wherein selecting the quantization level further comprises:
generating a bit count estimate based on the bit count;
comparing the bit count estimate to an ideal bit count, thereby producing a difference; and
selecting a quantizer level based on the difference.

20. The integrated circuit of claim 15, wherein the quantizer value is utilized by a block processor, wherein the block processor produces the input.
